(19) United States
(12) Patent Application Publication
(10) Pub. No.: US 2026/0105641 A1
(43) Pub. Date: Apr. 16, 2026

(54) Efficient Coding of Corner and Vertex Attributes

(71) Applicant: Apple Inc., Cupertino, CA (US)

(72) Inventors: Khaled Mammou, Danville, CA (US); David Flynn, Darmstadt (DE)

(21) Appl. No.: 19/358,357

(22) Filed: Oct. 14, 2025

Related U.S. Application Data
(60) Provisional application No. 63/707,594, filed on Oct. 15, 2024.

(51) Int. Cl. G06T 9/00

(52) U.S. Cl. CPC G06T 9/001

(57) ABSTRACT

Techniques are disclosed relating to mesh encoders and decoders that can decode encoded attribute bitstreams to determine attribute information for volumetric visual content. In some embodiments, decoding includes determining that the encoded attribute bitstream includes encoded information using implicitly defined attribute indices to map attribute vectors to corners of the polygons and, based on the determining, generating the attribute indices for inclusion in the determined attribute information. In some embodiments, decoding includes determining that an associated attribute index has not been previously encoded, determining an explicitly defined attribute index for the attribute vector by accessing a mapping data structure at a location associated with the given vertex. In some embodiments, decoding includes determining, based on metadata included in the encoded attribute bitstream, that the encoded attribute bitstream includes a deduplicated set of attribute vectors and explicitly defined attribute indices to associate the deduplicated set of attribute vectors to the vertices.

The present application claims priority to U.S. Prov. Appl. No. 63/707,594, entitled “Efficient Coding of Corner and Vertex Attributes,” filed Oct. 15, 2024, which is incorporated by reference herein in its entirety.

### BACKGROUND

### Technical Field

This disclosure relates generally to encoding and decoding of attribute information for three-dimensional meshes having associated textures or attributes.

### Description of the Related Art

Various types of sensors, such as light detection and ranging (LIDAR) systems, 3-D-cameras, 3-D scanners, etc. may capture data indicating positions of points in three-dimensional space, for example positions in the X, Y, and Z planes. Also, such systems may further capture attribute information in addition to spatial information for the respective points, such as color information (e.g., RGB values), texture information, intensity attributes, reflectivity attributes, motion related attributes, modality attributes, or various other attributes. In some circumstances, additional attributes may be assigned to the respective points, such as a time-stamp when the point was captured. Points captured by such sensors may make up volumetric visual content comprising mesh vertices each having associated spatial information and one or more associated attributes. In some circumstances, visual volumetric content may be generated, for example in software, as opposed to being captured by one or more sensors. In either case, such visual volumetric content may include large amounts of data and may be costly and time-consuming to store and transmit.

Such visual volumetric content may be represented by a three-dimensional mesh comprising a plurality of polygons (such as triangles) with connected vertices that model a surface of visual volumetric content. Moreover, texture or other attribute values may be overlaid on the mesh to represent the attributes of the visual volumetric content when modelled as a three-dimensional mesh.

### BRIEF DESCRIPTION OF THE DRAWINGS

FIG. 1 illustrates example mesh geometry information for visual volumetric content that may be used to encode/decode corner attributes, according to some embodiments.

FIG. 2 illustrates example attribute information that may be used to encode/decode corner attributes, according to some embodiments.

FIG. 3 illustrates an example process of using mesh geometry information, attribute information, and vertex to attribute mappings to encode/decode corner attributes to reconstruct a representation of volumetric visual content, according to some embodiments.

FIG. 4 illustrates example mesh geometry information for a polygonal mesh that contains different types of polygons that may be used to encode/decode corner attributes, according to some embodiments.

FIG. 5 illustrates example mesh geometry information for a polygonal mesh that contains different types of polygons that may be triangulated using virtual edges to encode/decode corner attributes, according to some embodiments.

FIG. 6 illustrates an example encoder for compressing and/or encoding visual volumetric content that may be used to encode/decode corner attributes, according to some embodiments.

FIG. 7 illustrates an attribute vector encoder that uses an encoding order and prediction neighborhood information to generate a compressed attribute vectors bitstream, according to some embodiments.

FIG. 8A-8E illustrate attribute prediction configurations for predicting an attribute value for a vertex of a triangle, according to some embodiments.

FIG. 9 illustrates an example exchange between an encoder and a decoder using efficient coding of corner and vertex attributes.

FIG. 10 illustrates an example computer system that may implement an encoder or decoder, according to some embodiments.

### DETAILED DESCRIPTION

As data acquisition and display technologies have become more advanced, the ability to capture visual volumetric content comprising thousands or millions of points in 2-D or 3-D space, such as via LIDAR systems, has increased. Large visual volumetric content files may be costly and time-consuming to store and transmit. For example, communication of visual volumetric content over the Internet requires time and network resources, resulting in latency.

In some embodiments, an encoder generates compressed visual volumetric content to reduce costs and time associated with storing and transmitting visual volumetric content. In some embodiments, a system may include an encoder that compresses attribute and/or spatial information of a visual volumetric content file such that the visual volumetric content file may be stored and transmitted more quickly than non-compressed visual volumetric content and in a manner that the visual volumetric content file may occupy less storage space than non-compressed visual volumetric content. In some embodiments, compression of attributes for vertices in visual volumetric content may enable the visual volumetric content to be communicated over a network in real-time or in near real-time. For example, a system may include a sensor that captures attribute information about points in an environment where the sensor is located, wherein the captured points and corresponding attributes make up visual volumetric content. The system may also include an encoder that compresses the captured visual volumetric content attribute information. The compressed attribute information of the visual volumetric content may be sent over a network in real-time or near real-time to a decoder that decompresses the compressed attribute information of the visual volumetric content. The decompressed visual volumetric content may be further processed, for example to make a control decision based on the surrounding environment at the location of the sensor. The control decision may then be communicated back to a device at or near the location of the sensor, wherein the device receiving the control decision implements the control decision in real-time or near real-time. In some embodiments, the decoder may be associated with an augmented reality system and the decompressed attribute information may be displayed or otherwise used by the augmented reality system. In some embodiments, compressed attribute information for a visual volumetric content may be sent with compressed spatial information for the visual volumetric content, such as an encoded mesh. In other embodiments, spatial information and attribute information may be separately encoded and/or separately transmitted to a decoder.

In some embodiments, a system may include a decoder that receives one or more sets of visual volumetric content data comprising compressed attribute information via a network from a remote server or other storage device that stores the one or more visual volumetric content files. For example, a 3-D display, a holographic display, or a head-mounted display may be manipulated in real-time or near real-time to show different portions of a virtual world represented by visual volumetric content. In order to update the 3-D display, the holographic display, or the head-mounted display, a system associated with the decoder may request visual volumetric content data from the remote server based on user manipulations of the displays, and the visual volumetric content data may be transmitted from the remote server to the decoder and decoded by the decoder in real-time or near real-time. The displays may then be updated with updated visual volumetric content data responsive to the user manipulations, such as updated point attributes.

In some embodiments, a system, may include one or more LIDAR systems, 3-D cameras, 3-D scanners, etc., and such sensor devices may capture spatial information, such as X, Y, and Z coordinates for points in a view of the sensor devices. In some embodiments, the spatial information may be relative to a local coordinate system or may be relative to a global coordinate system (for example, a Cartesian coordinate system may have a fixed reference point, such as a fixed point on the earth, or may have a non-fixed local reference point, such as a sensor location).

In some embodiments, such sensors may also capture attribute information for one or more points, such as color attributes, texture attributes, reflectivity attributes, velocity attributes, acceleration attributes, time attributes, modalities, and/or various other attributes. In some embodiments, other sensors, in addition to LIDAR systems, 3-D cameras, 3-D scanners, etc., may capture attribute information to be included in visual volumetric content. For example, in some embodiments, a gyroscope or accelerometer, may capture motion information to be included in visual volumetric content as an attribute associated with one or more mesh vertices of the visual volumetric content. For example, a vehicle equipped with a LIDAR system, a 3-D camera, or a 3-D scanner may include the vehicle's direction and speed in visual volumetric content captured by the LIDAR system, the 3-D camera, or the 3-D scanner. For example, when points in a view of the vehicle are captured, they may be included in visual volumetric content, wherein the visual volumetric content includes mesh information representing the captured points and associated motion information corresponding to a state of the vehicle when the points were captured.

In some embodiments, multiple ones of the attribute vectors that have the same values may be associated with a same geometry index of the geometry indices for the plurality of vertices. This may particularly be the case for corner attributes. For example, as explained above, a vertex in a 3D mesh may be associated with multiple vertices of 2D texture image when cut along an edge containing the vertex. Because a vertex in the 3D mesh may be represented now in multiple vertices in the 3D image, there may be multiple attribute indices that are associated the attribute of the vertex. Furthermore, multiple values of differing types of attribute information, such as texture coordinates, normal vectors, color information (e.g., RGB values, YCbCr values, etc.), may be associated with same ones of the mesh vertices. Efficient encoding of such corner attributes may be required to improve overall compression efficiency of visual volumetric content.

While several of the examples described herein focus on compressing and decompressing texture coordinates using geometry information guided prediction, in some embodiments, the same techniques described herein may be applied to compress and decompress any attribute values using geometry information guided prediction.

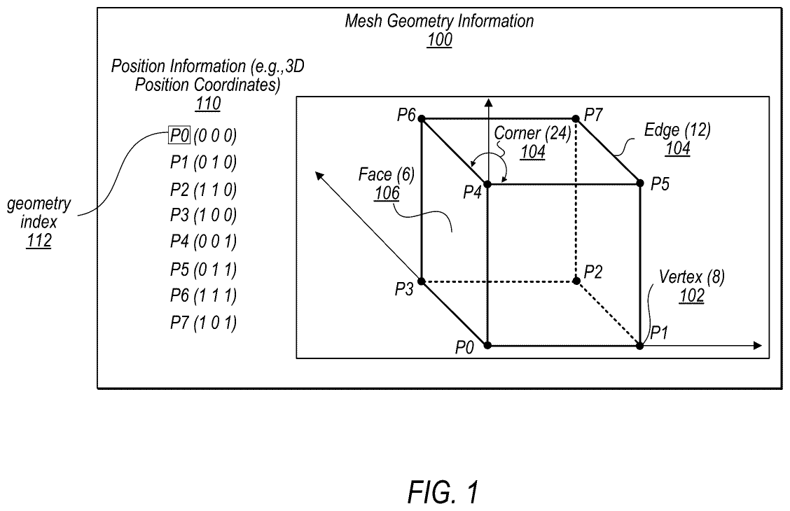

FIG. 1 illustrates an example mesh geometry information for a visual volumetric content that may be used to encode/decode corner attributes, according to some embodiments.

For example, in some embodiments, a mesh geometry information 100 may comprise a plurality of vertices, geometry connectivity information for forming polygons using the plurality of vertices, and geometry indices. In some embodiments, the connectivity information may be series of geometry indices that indicate which of the vertices are connected to form edges of the polygons. Moreover, in some embodiments, the geometry indices may indicate which of the attribute vectors (e.g., the 3D position coordinates) are associated with a given vertex of the plurality of vertices. For example, a vertex 102 having a geometry index 112 “P1” is connected to vertex having index P0 to form an edge. In another example, a vertex P5 may connect to vertex P7 to form an edge 104. The mesh geometry information 100 may furthermore comprise position information 110 such as three-dimensional (3D) position coordinates indicating locations of the plurality of plurality of vertices 102. In FIG. 1, the plurality of vertices 102 and the connectivity information are associated with a 3D cube having eight vertices P0-P7, twelve edges, twenty-four corners, and six faces. In some embodiments, the angle of corners may be provided or be calculated using the position information 110 and the connectivity information.

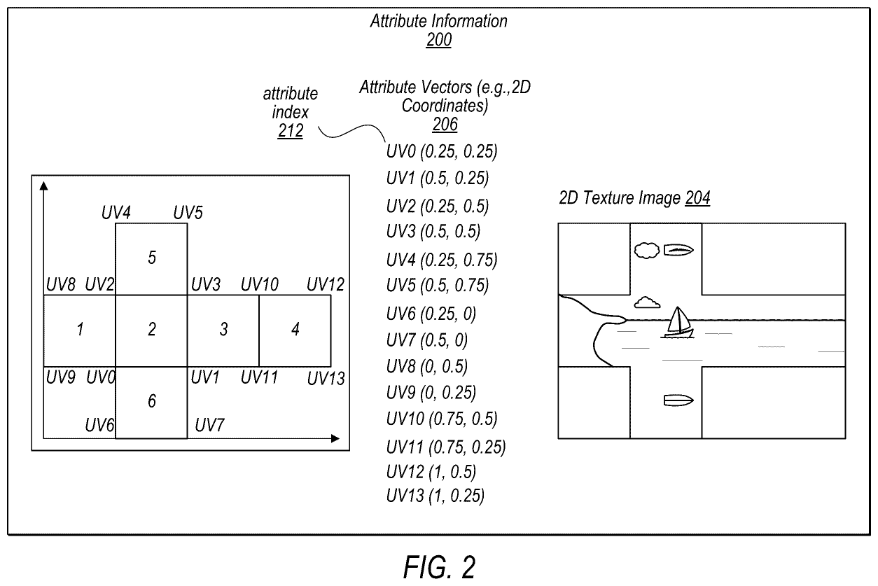

FIG. 2 illustrates an example attribute information that may be used to encode/decode corner attributes, according to some embodiments.

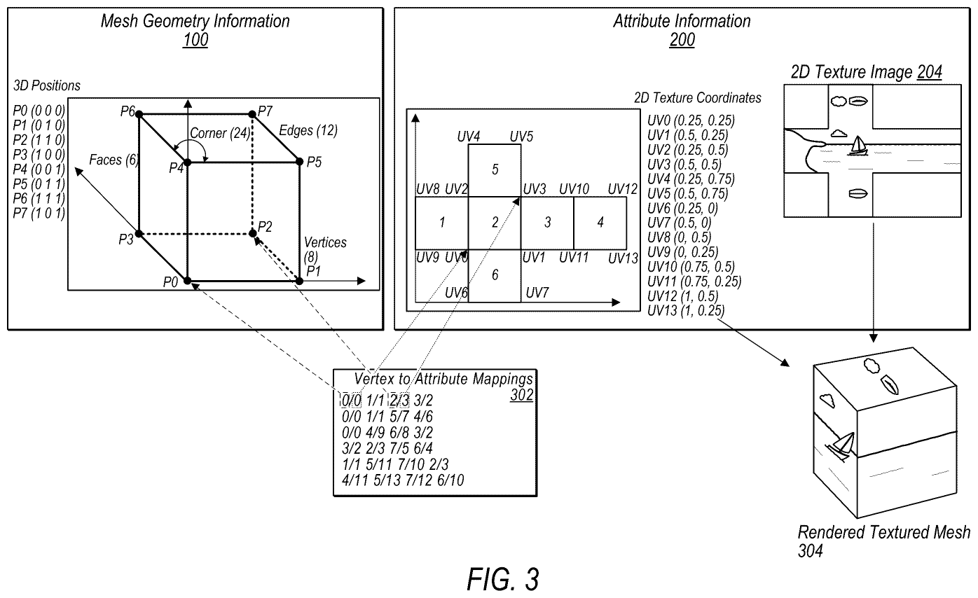

In some embodiments, attribute information 200 for a volumetric visual content may comprise attribute vectors 206, attribute indices for the attribute vectors, and attribute connectivity information for associating attribute vectors with the plurality of geometry vertices. For example, the attribute vectors may be coordinates of a two-dimensional (2D) texture image 204. The attribute indices may be used to indicate which of the attribute vectors (e.g., the 2D coordinates) are associated with which corresponding geometry vertices of a mesh geometry information. For example, attribute index 212 “UV0” may be used to indicate that coordinate (0.25, 0.25) is associated with vertex P0 of corresponding mesh geometry information as further discussed in FIG. 3.

FIG. 3 illustrates an example process of using mesh geometry information, attribute information, and vertex to attribute mappings to encode/decode corner attributes to reconstruct a volumetric visual content, according to some embodiments.

In some embodiments, vertex to attribute mappings 302 may describe the relationship between a plurality of geometry vertices of a mesh geometry information 100 with a plurality of attribute values, including attribute vectors (e.g., 2D texture coordinates), of an attribute information for a volumetric visual content. For example, the vertex to attribute mappings 302 may indicate that a vertex having index P0 at position vector (0 0 0) may be associated with attribute index UV0 with attribute vector (0.25, 0.25). The vertex to attribute mappings 302 may furthermore indicate that a vertex having geometry index P2 is associated with an attribute index UV3. In some embodiments, the 2D texture image may be an image 204 of an unfolded three-dimensional (3D) mesh such that multiple ones of the coordinates of the 2D texture image are associated with a same geometry index of the geometry indices for the plurality of vertices. For example, attribute indices UV6, UV9, and UV13 indicating attribute vectors (0.25, 0), (0, 0.25), and (1, 0.25) respectively may be associated with a same geometry vertex P4 at position (0 0 1). In some embodiments, the mesh geometry information 100 and the attribute information 200 may be mapped using the vertex to attribute mappings 302 to generate a rendered textured mesh 304.

In some embodiments, one or more portions of the mesh geometry information 100, attribute information 200, and the vertex to attribute mappings 302 may be encoded to generate an encoded attribute indices bitstream to compress the relevant attribute and/or geometry information of a visual volumetric content file such that the visual volumetric content file may be stored and transmitted more quickly than a non-compressed visual volumetric content and in a manner that the visual volumetric content file may occupy less storage space than non-compressed visual volumetric content. In some embodiments, encoding of attributes for vertices in visual volumetric content may enable the visual volumetric content to be communicated over a network in real-time or in near real-time. For example, a system may include a sensor that captures attribute information about points in an environment where the sensor is located such that the captured points and corresponding attributes make up visual volumetric content. The system may also include an encoder that encodes the captured visual volumetric content attribute information. The encoded attribute information of the visual volumetric content may be sent over a network in real-time or near real-time to a decoder that decodes the encoded attribute information of the visual volumetric content. The decoded visual volumetric content may be further processed, for example to make a control decision based on the surrounding environment at the location of the sensor. The control decision may then be communicated back to a device at or near the location of the sensor. The device receiving the control decision implements the control decision in real-time or near real-time. In some embodiments, the decoder may be associated with an augmented reality system and the decoded attribute information may be displayed or otherwise used by the augmented reality system. In some embodiments, encoded attribute information for a visual volumetric content may be sent with encoded spatial information for the visual volumetric content, such as an encoded mesh. In other embodiments, spatial information and attribute information may be separately encoded and/or separately transmitted to a decoder.

### Encoding Corner Attribute Indices Using Quantities of Attribute Indices and Vertex to Attribute Mappings

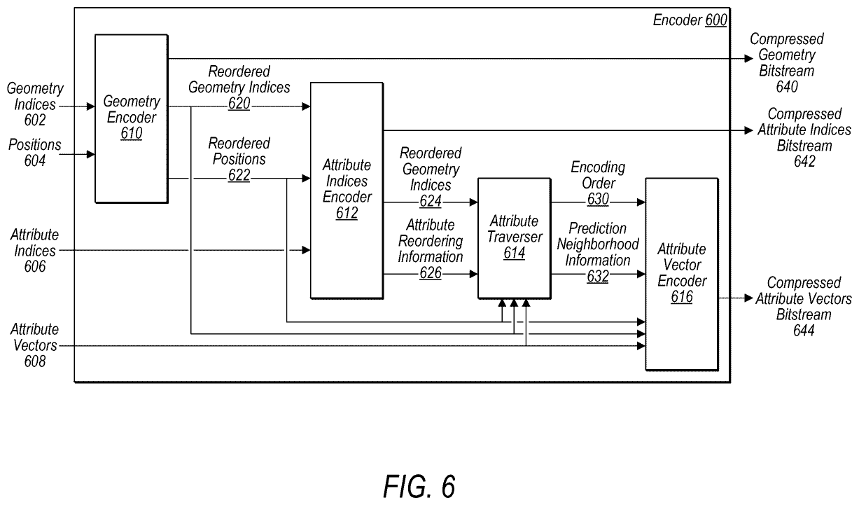

In some embodiments, an attribute indices encoder (further discussed in FIG. 6) may generate an encoded attribute indices bitstream, wherein the attribute indices bitstream is decodable in order to reconstruct a volumetric visual content. In some embodiments, to generate an encoded attribute indices bitstream, the attribute indices encoder may determine vertex to attribute mappings in which the vertex attribute mappings may store for each vertex v of the geometry vertices, attribute indices of the attribute vectors associated with the vertex.

In some embodiments, the attribute indices encoder may determine respective quantities of attribute indices associated with the respective ones of the plurality of vertices (|∇(v)|) for respective attribute indices (∇(v)). For instance, in FIG. 3, a vertex having index value v=4 (“P4”, or “vertex 4”) has three attributes (e.g., attribute “a”, a0=6, a1=9, and a1=13) associated with the vertex. The attribute indices and quantity of attribute indices associated with associated with the geometry vertex 4 may be expressed as follows:

$$∇ ( 4 ) = \{ 6 , 9 , 13 \} and \vert ∇ ( 4 ) \vert = 3.$$

In some embodiments, the attribute indices encoder may determine the relationship between the plurality of geometry vertices, attribute indices, and quantities of attribute indices associated with the respective ones of the geometry indices. In some embodiments, the relationship may be expressed using a following table data structure.

| ν | ∇(ν) | \|∇(ν)\| |
|---|---|---|
| 0 | 0 | 1 |
| 1 | 1 | 1 |
| 2 | 3 | 1 |
| 3 | 2 | 1 |
| 4 | 6, 9, 13 | 3 |
| 5 | 7, 11 | 2 |
| 6 | 8, 4, 12 | 3 |
| 7 | 5, 10 | 2 |

In some embodiments, the attribute indices encoder may determine the vertex to attribute mappings between respective ones of the plurality of vertices and respective ones of the attribute indices by traversing the geometry vertices according to a traversal order. For example, the attribute indices encoder may determine the vertex to attribute mappings by traversing mesh faces of the mesh geometry information 100 according to a traversal order as determined by a geometry encoder. In some embodiments, geometry indices used for the vertex to attribute mappings may be a reordered geometry indices that has been reordered by the geometry encoder in generating a compressed geometry bitstream.

In some embodiments vertex to attribute mapping may be a sequence of attribute indices. For example, the mesh faces (or the reordered mesh faces) may be traversed according to the traversal order, and for each corner of the face the vertex v(h) and attribute index i(h) of the face may be determined. If the attribute index i(h) has already been added to the vertex to attribute mapping (e.g., the indices sequence), the attribute index would not be added. If the attribute index i(h) has not been added to the vertex to attribute mapping i(h) is appended to the vertex to attribute mapping as ∇(v(h)). In some embodiments, the attribute indices encoder may traverse the attribute indices (and therefore add the attribute indices) in the traversal order.

In some embodiments, to generate an encoded attribute indices bitstream, the attribute indices encoder may encode information indicating the respective quantities of attribute indices associated with the respective ones of the plurality of vertices. For example, the attribute indices encoder may determine the number of the faces |F(v)| incident to each vertex v of the plurality of geometry vertices. The attribute indices encoder may determine that lowest (minimum) quantity of attributes associated with any of the plurality of geometry vertices (Nₘᵢₙ) and highest (maximum) quantity of attributes associated with any of the plurality of geometry vertices (Nₘₐₓ) are to be defined as follows:

$${N}_{min} = {min}_{v} ( \vert ∇ ( v ) \vert ) , and {N}_{max} = {min}_{v} ( \vert ∇ ( v ) \vert ) .$$

The attribute indices encoder may determine a range of the respective quantities of attribute indices associated with the plurality of vertices (R), wherein

$$R = {N}_{max} - {N}_{min} .$$

In some embodiments, the attribute indices encoder may encode the lowest quantity of the respective quantities of attribute indices associated with the plurality of vertices and the range of the respective quantities of attribute indices into the attribute indices bitstream. In some embodiments, the Nₘᵢₙ and R may be encoded into the attribute indices bitstream using one or more entropy encoders. In some embodiments, entropy encoders may include one or more different types of entry encoders such as exponential golomb coding, context adaptive binary arithmetic coding with truncated unary codes, etc.

In some embodiments, for each vertex v, the attribute indices encoder may encode quantities of associated attributes indices for each of the geometry indices for the plurality of vertices, wherein the attribute indices encoder encodes |∇(v)| into the attribute indices bitstream. In some embodiments, the attribute indices encoder may reduce the reduced each one of the quantities of attributes associated with the geometry indices by the lowest quantity of attributes (|∇(v)|−Nₘᵢₙ) to further compress the information being encoded by exploiting the fact that attribute indices fall between 0 and R. In some embodiments, truncated unary coding may be used as described in the following.

| | | Truncated |
|---|---|---|
| | | Unary (TrU) |
| N | Unary (U) | cMax = 7 |
| 0 | 0 | 0 |
| 1 | 10 | 10 |
| 2 | 110 | 110 |
| 3 | 1110 | 1110 |
| 4 | 11110 | 11110 |
| 5 | 111110 | 111110 |
| 6 | 1111110 | 1111110 |
| 7 | 11111110 | 1111111 |

In some embodiments, to generate an encoded attribute indices bitstream, the attribute indices encoder may reorder attribute indices and encode updated vertex to attribute mappings. In some embodiments, the attribute indices encoder may determine an array M of size A, wherein A is equal to the total number of attribute indices in the attribute information 200. The attribute indices encoder may store a new index of an attribute vector in the array M after the reordering. Furthermore, the attribute indices encoder may determine an array M⁻¹ that is an inverse mapping of M.

In some embodiments, the attribute indices encoder may initialize M⁻¹=M={−1, −1, . . . , −1}, and initialize an attribute counter C=0. In some embodiments, instead of the value −1, other values or symbol may indicate that an attribute index has not yet been visited in the traversal. For each vertex v, the attribute indices encoder may traverse the elements of ∇(v)={i(0), i(1), . . . , i(|∇(v)|−1)} and may determine whether an attribute index of the attribute indices associated with a given corner has been visited in the traversal. The attribute indices encoder may determine whether M(i(k))=−1 (or instead of −1, another indicator that indicates whether attribute i(k) has or has not been visited before) in the traversal.

Based on a determination that the attribute index has not been visited in the traversal, the attribute indices encoder may encode the value 1 (or another indicator) to indicate to the decoder that the next attribute is a new attribute. In some embodiments, based on the determination that attribute i(k) has not been visited before in the traversal, the attribute indices encoder may set M(i(k))=C, M⁻¹ (C)=i(k), and increment the counter C=C+1. In some embodiments, the value 1 (or other indicator) may indicate to the decoder that the next attribute is a new attribute may be encoded using one or more entropy encoders as discussed above.

In some embodiments, the attribute indices encoder may determine that M(i(k))≠−1 (or another indicator that indicates that attribute i(k) has been visited before). Based on a determination that the attribute index has been visited in the traversal, the attribute indices encoder may encode the value 0 to indicate to the decoder that the next attribute is an old attribute. The attribute indices encoder may encode the value (C−M (i(k))−1) based on the determination that the attribute index has been visited in the traversal. In some embodiments, the value (C−M (i(k))−1) may be encoded using one or more entropy encoders as discussed above. During the traversal, the attribute indices encoder may determine that C<A and may determining that for i=0, . . . , A−1, if M (i)=−1 to set M (i(k))=C and M⁻¹ (C)=i(k). The attribute indices encoder may increment the counter C=C+1, and add the remaining attribute indices in an order that maximizes correlations between successive attributes.

In some embodiments, the attribute indices encoder may encode attribute indices into the encoded attribute indices bitstream. The attribute indices encoder may use the previously encoded vertex to attribute mapping and the encoded quantities of the attribute indices in order to encode the attribute indices into the bitstream. For example, as part of the encoding process, the attribute indices encoder may determine two array, S and L to be two arrays of size V, where V is the number of the vertices of the mesh geometry information 100. The attribute indices encoder may initialize L=S={−1, −1, . . . , −1} (or instead of −1, another indicator that indicates whether attribute i(k) has not been visited before). In some embodiments, the attribute indices encoder may initiate traversal of the faces of the mesh and for each face, process its corners (v(h), i(h)). If the quantity of attribute indices associated with a given corner |∇(v(h))|≤1, the attribute indices encoder may proceed onto the next corner, but if the quantity of attribute indices associated with a given corner |∇(v(h))|>1 the attribute indices encoder may determine whether S(v(h))=−1 (or other indication that that this is the first time that the vertex is visited in the traversal). Based on the determination that the attribute index has not been visited in the traversal, the attribute indices encoder may set L(v(h))=0, and S(v(h))=0 given that i(h) is the first element of ∇(v(h)) (e.g., element at index α of array of attribute indices for the given vertex).

In some embodiments, based on the determination that the attribute index has been visited in the traversal, the attribute indices encoder may determine an index indicating a location of the attribute index in an array of attribute indices for a vertex of the plurality of vertices associated with the given corner. For example, the attribute indices encoder may determine the index k of i(h) in the list ∇(v(h)). In another example, the attribute indices encoder may determine index “1” for attribute index “9” given an array {6, 9, 13} for ∇(4). The attribute indices encoder may encode the determined index indicating the location of the attribute index into the encoded attribute indices bitstream. In some embodiments, the attribute indices encoder may encode the local index k by exploiting the following facts k<|∇(v(h))| and k≤S(v(h))+1. The attribute indices encoder may then set L(v(h))=k, and S(v(h))=max {S(v(h)), k}.

### Decoding Corner Attribute Indices Using Quantities of Attribute Indices and Vertex to Attribute Mappings

In some embodiments, an encoded attribute indices bitstream may be used by a decoder to reconstruct a volumetric visual content. In some embodiments, the decoder may receive an encoded geometry bitstream, an encoded attribute vector bitstream, and an encoded attribute indices bitstream. To reconstruct a volumetric visual content, the decoder may decode the encoded geometry bitstream to determine mesh geometry information for volumetric visual content, the mesh geometry information comprising position information for a plurality of vertices, geometry connectivity information for forming polygons using the plurality of vertices, and geometry indices for the plurality of vertices.

In some embodiments, the encoded attribute indices bitstream may comprise encoded information indicating respective quantities of attribute indices associated with the respective ones of the plurality of vertices, encoded information indicating vertex to attribute mappings, and encoded attribute indices. In some embodiments, the encoded information indicating respective quantities of attribute indices associated with the respective ones of the plurality of vertices, the encoded information indicating vertex to attribute mappings, and the encoded attribute indices may be determined using an encoding process described above.

To reconstruct a volumetric visual content, the decoder may decode Nₘᵢₙ and R from the bitstream to determine the lowest (minimum) quantity of attributes associated with any of the plurality of geometry vertices (Nₘᵢₙ) and the range of the respective quantities of attribute indices associated with the plurality of vertices (R). In some embodiments, for each vertex v, the decoder may decode the number of its associated attributes indices, decode the value (|∇(v)|−Nₘᵢₙ), while exploiting the fact that it is between 0 and R. As discussed above, the Nₘᵢₙ and R may be decoded from the attribute indices bitstream using one or more entropy encoders that were used in the encoding process (such as one or more different types of entry encoders such as exponential golomb coding, context adaptive binary arithmetic coding with truncated unary codes, etc.). The decoder may determine |∇(v)| for each one of the geometry indices for the plurality of vertices by increase each of the quantities by Nₘᵢₙ.

To reconstruct a volumetric visual content, the decoder may decode the vertex to attribute mappings. The decoder may initialize the attribute counter C=0, initialize ∇(v)={ }, for v=0 . . . . V−1. For each vertex v, the decoder may decode 1 bit from the bitstream and determine whether the decoded bit equals 1. Based on a determination that the decoded bit equals 1, the decoder may create a new attribute index i(k)=C+1, append i(k) to the end of ∇(v), and increment the counter C=C+1. Based on a determination that the decoded bit does not equal 1, the decoder reuses the existing attribute index i(k) and decode the value τ from the bitstream to set i(k)=C+1+τ (which is opposite of the encoding step wherein value, (C−M (i(k))−1), was encoded).

To reconstruct a volumetric visual content, the decoder may decode the attribute indices, while leveraging the previously decoded vertex to attribute mapping. In some embodiments, the decoder may determine two array, S and L to be two arrays of size V′, where I′ is the number of the vertices of the mesh geometry information 100. The decoder may initialize L=S={−1, −1, . . . , −1} (or instead of −1, another indicator that indicates whether attribute i(k) has not been visited before, similar to the encoding process). In some embodiments, the decoder may initiate traversal of the faces of the mesh and for each face, process its corners (v(h), i(h)) according to the same traversal order for the geometry indices used in the encoding. If the quantity of attribute indices associated with a given corner |∇(v(h))|≤1, decoder may proceed onto the next corner, but if the quantity of attribute indices associated with a given corner |∇(v(h))|>1 the decoder may determine whether S(v(h))=−1 (or other indication that that this is the first time that the vertex is visited in the traversal). Based on the determination that the attribute index has not been visited in the traversal, the decoder may set L(v(h))=0, and S(v(h))=0 given that i(h) is the first element of ∇(v(h)) (e.g., element at index 0 of array of attribute indices for the given vertex).

In some embodiments, based on the determination that the attribute index has been visited in the traversal, the decoder may decode from the attribute indices bitstream a local index k. The decoder may exploit the fact that k<|∇(v(h))|, and k≤S(v(h))+1, because of the way the vertex to attribute mappings were computed on the encoder side and set i(h) to be equal to the k-th element of ∇(v(h)). The decoder may determine, determination that the attribute index has been visited in the traversal, that L (v(h))=k, and S(v(h))=max {S(v(h)), k}. The decoder may reconstruct the volumetric visual content using the decoded attribute indices along with attribute vectors determined from decoding the encoded attribute vector bitstream and the mesh geometry information for volumetric visual content.

### Encoding Corner Attribute Indices Using Corner Table Data Structure

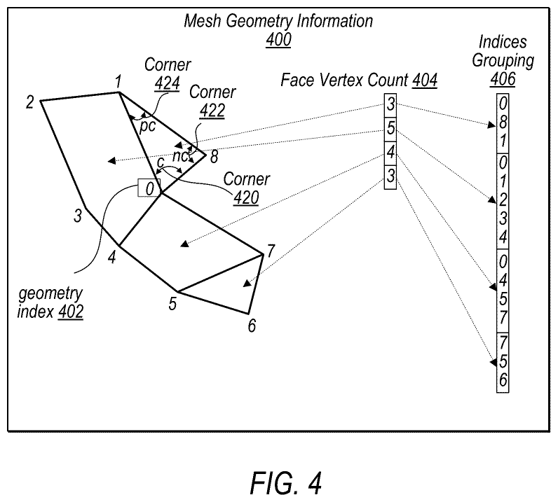

FIG. 4 illustrates an example mesh geometry information for polygonal mesh that contain different types of polygons that may be used to encode/decode corner attributes, according to some embodiments.

In some embodiments, an attribute indices encoder may obtain a mesh geometry information 400 comprising position information for a plurality of vertices, geometry connectivity information for forming polygons using the plurality of vertices, and geometry indices for the plurality of vertices non-manifold polygonal meshes. For example, the mesh geometry information 400 may indicate that geometry vertex having the geometry index “0” 402 may be in position as shown in FIG. 4. In some embodiments, the mesh geometry information 400 may include position coordinates for each of the vertices as shown in FIG. 1.

In some embodiments, the attribute indices encoder may generate an encoded attribute indices bitstream such that the attribute indices bitstream is decodable in order to reconstruct a volumetric visual content. To generate the encoded attribute indices bitstream, the attribute indices encoder may generate a data structure to describe various corners of the polygons. In some embodiments, the data structure (e.g., a corner table) may represent a connectivity information for a polygonal mesh, wherein the corner table indicates for respective corners of the polygons, respective corner indices, respective vertices of the plurality of vertices, and relationships between the respective corners and other corners adjacent to the respective corners. For example, the corner table may indicate the relationships between the respective corners such as the identity of a next corner “nc” 422 from a given corner “c” 420 according to a traversal order (e.g., corner to the right of the given corner) and a previous corner “pc” 424 from the given corner 420 according to the traversal order (e.g., corner to the left of the given corner). The traversal order may be based on based on a rule used in encoding of the mesh geometry information 400. In some embodiments, the traversal order may be based on a rule to traverse to a corner adjacent to right (or to the left) of a previously visited corner.

In some embodiments, to generate the encoded attribute indices bitstream, the attribute indices encoder may furthermore determine a face vertex count array 404 and an indices grouping array 406. The face vertex count array 404 may be a one-dimensional (1D) array of size F that stores the number of vertices for each face. For example, in FIG. 4, the polygonal mesh represented by the geometry information 400 has 4 faces, and therefore has an array size of 4. Moreover, values stored in the face vertex count may represent the number of corners that each of the respective polygons contain. For example, the first value “3” in the face vertex count 404 represents three corners of the triangle associated with the triangle. In some embodiments, the indices grouping array 406 may be an array that indicates the geometry indices of the faces that make up the respective faces represented in the face vertex count 404. For example, the first three indices of the indices grouping, “0”, “8”, and “1” indicates the geometry indices of the triangle associated with the triangle represented by the first value of the face vertex count 404.

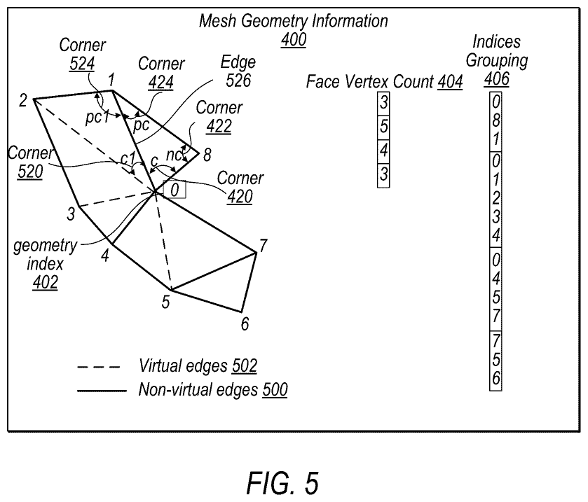

In some embodiments, to generate the encoded attribute indices bitstream, the attribute indices encoder may triangulate one or more polygons having more than three edges (e.g., quadrilaterals, pentagons, etc.) represented in the geometry information 400 by using one or more virtual edges according to a virtual edge generation order. For example, FIG. 5 illustrates an example mesh geometry information for polygonal mesh that contain different types of polygons that may be triangulated using virtual edges to encode/decode corner attributes, according to some embodiments.

To generate the encoded attribute indices bitstream, the attribute indices encoder may triangulate the polygonal mesh using virtual edges 502 and determine additional corners that are formed using the virtual edges 502. For example, FIG. 5 illustrates corner “c1” 520 that is generated by triangulating the pentagon comprising geometry vertices indicated by geometry indices “0”, “1”, “2”, “3”, and “4”. The attribute indices encoder may generate a data structure to describe various corners of the polygons subsequent to the triangulation, in some embodiments. In some embodiments, the attribute indices encoder may furthermore determine a corner-to-index array (a 1D array of size (3×T) that stores for each corner the index of the associated vertex in the indices arrays), vertex-to-corner adjacency information (information indicating for each of the corners of the polygons indices of all the corners incident to it), and edge tag array (a 1D array of size (3×T) that stores for each corner whether its opposite edge is a virtual edge or not).

In some embodiments, to generate the encoded attribute indices bitstream, the attribute indices encoder may encode attribute indices by leveraging data structure (e.g., the corner table) determined above. For example, the attribute indices encoder may determine an array M of size A that stores attribute indices information based on the geometry indices traversal order. Additionally, the attribute indices encoder may determine an array M⁻¹ that is an inverse mapping of M. The attribute indices encoder may generate array S of size CC, (wherein CC is the number of corners) which stores for each corner its status whether the corner has been visited in a traversal or not. In some embodiments, the attribute indices encoder may initialize M⁻¹=M={−1, −1, . . . , −1}, initialize S={false, false, . . . , false}, and initialize an attribute counter C=0.

In some embodiments, the attribute indices encoder may determine the vertex to attribute mappings between respective ones of the plurality of vertices and respective ones of the attribute indices by traversing the geometry vertices according to a traversal order. The attribute indices encoder may traverse each corner c0 and determine whether the corner has been visited during the traversal or not. For example, if S[c0]==true. If the attribute indices encoder determines that S[c0]==true the corner c is skipped since it was already processed. However, if S[c0]==false, the attribute indices encoder set S[c0]=true, and determines attribute index i(c0) associated with the corner c.

If the attribute indices encoder determines that M(i(c0))=−1 (e.g., that the attribute index i(c0) was not visited before), then the attribute indices encoder encodes the value 1 to the encoded attribute indices bitstream to indicate to a decoder that the next attribute is a new attribute. The attribute indices encoder then encodes the attribute index associated with the corner. As discussed above, the value 1 and the attribute index associated with the corner may be encoded using one or more entropy encoders (exponential golomb coding, context adaptive binary arithmetic coding with truncated unary codes, etc.) as discussed above. The attribute indices encoder then sets M(i(c0))=C, M⁻¹ (C)=i(k), and increment the counter C=C+1.

If the attribute indices encoder determines that M(i(c0))≠−1 (e.g., that the attribute index i(c0) was visited before), the attribute indices encoder encodes the value 0 to indicate to the decoder that the next attribute is an old attribute and encodes the value (C−M (i(k))−1) into the attribute indices bitstream. The attribute indices encoder then sets c=c0.

In some embodiments, the attribute indices encoder traverses all the corner adjacent to c on its left, wherein c1=geomCornerTable. SwingLeft (c), and determines whether c1<0 or S[c1]==true. If c1<0, this indicates that the corner c1 does not exist (the corner table indicates using-1 that a value does not exist). If [c1]==true, this indicates that the corner has been visited in the traversal. Based on the determination that c1<0 or S[c1]==true. If c1<0 exit the loop and traverses to the next corner according to the traversal order. Otherwise, attribute indices encoder determines the next corner, nc=geomCornerTable.Next(c), and determines whether the edge opposite to nc is not virtual, geomCornerTable.edgeTag(nc)==false.

If the edge opposite to nc is not virtual, the attribute indices encoder may determine that attribute index i(c1) associated with c1 is the same as the attribute index i(c0) associated with c0. For example, based on the determination that edge 526 is not virtual, the attribute indices encoder may determine that two corners (corner pc 424 and corner pc1 524) that are formed using the edge 526 and other edges connected to vertex “1” on an opposite end of the edge 526 are associated with same attribute index. The attribute indices encoder sets attribute index σ=i(c1)==i(c0), pc=geomCornerTable. Previous (c), and pc1=geomCornerTable. SwingRight (pc). The attribute indices encoder then determines if S[pc]==true (e.g., that pc has been visited in the traversal) or (pc1≥0 and S[pc1]==true) (e.g., that pc1 exists and has been visited in the traversal). Based on the determination that, attribute indices encoder sets σ0=S[pc]==true and (pc1≥0 and S[pc1]==true) and i(pc1)==i(pc). The attribute indices encoder encodes the Boolean value (σ xor σ0) into the attribute indices encoder bitstream. Based on the determination that S[pc]==false (e.g., that pc has not been visited in the traversal) or (pc1<0 or S[pc1]==false) encode the Boolean value σ. If the edge opposite to nc is not virtual, the attribute indices encoder sets S[c1]=true, sets c=c1, and set c=c0. Once all of the corners to the left of the given corner have been traversed, the same is repeated for corners to the right.

### Decoding Corner Attribute Indices Using Corner Table Data Structure

In some embodiments, an encoded attribute indices bitstream may be used by a decoder to reconstruct a volumetric visual content. In some embodiments, the decoder may receive an encoded geometry bitstream, an encoded attribute vector bitstream, and an encoded attribute indices bitstream. As discussed above, to reconstruct a volumetric visual content, the decoder may decode the encoded geometry bitstream to determine mesh geometry information for volumetric visual content, wherein the mesh geometry information comprise position information for a plurality of vertices, geometry connectivity information for forming polygons using the plurality of vertices, and geometry indices for the plurality of vertices.

To decode the encoded geometry bitstream, the decoder may first initialize M⁻¹=M={−1, −1, . . . , −1}, initialize S={false, false, . . . , false}, and initialize an attribute counter C=0. The decoder may then traverse the corners of the polygons represented in the mesh geometry information 400 according to a traversal order. For each corner c0, the decoder may determine if S[c0]==true. If true, the decoder skips corner c since it was already processed. If false, the decoder sets S[c0]=true, determines i(c0) attribute index associated with the corner c, and decode 1 bit from the encoded attribute indices bitstream.

Based on the determination that the decoded bit equals 1, then decoder create a new attribute index i(k)=C+1, append i(k) to the end of ∇(v), and increment the counter C=C+1. Based on the determination that the decoded bit does not equal 1, the decoder reuses an existing attribute index i(k), and decode the value τ from the encoded attribute indices bitstream and determines that i(k)=C+1+τ. As discussed above, the decoding may be performed using one or more entropy encoders used in the encoding process. To decode the encoded geometry bitstream, the decoder may traverse each corner c0 and determine whether the corner has been visited during the traversal or not. However, instead of encoding the Boolean value into the attribute indices bitstream, the decoder may decode the Boolean value from the attribute indices bitstream. For example, the decoder may decode the Boolean value (σ xor σ0) based on determining that S[pc]==true or (pc1≥0 and S[pc1]==true).

FIG. 6 illustrates an example encoder 600 for compressing and/or encoding visual volumetric content that may be used to encode/decode corner attributes, according to some embodiments.

### Example Attribute Traverser

In some embodiments, an attribute traverser 614 determine an encoding order and prediction neighborhood information that may be used by an attribute vector encoder to process attribute values (e.g., attribute vectors) in the same order for the compressed attribute vectors bitstream.

To determine the encoding order, the attribute traverser generates a data structure (e.g., a corner table) that represents a connectivity information for a polygonal mesh as discussed above at FIG. 4. The attribute traverser determines attributeStatus to be an array of size A (where A is the number of attribute vectors) that indicates for each attribute vector whether it was encoded or not. The attribute traverser determines cornerStatus be an array of size CC (where CC is the number of corners) that indicates for each corner whether it was traversed or not. The attribute traverser sets array M be an array of size A that stores the new index of an attribute after re-ordering, and set M⁻¹ the inverse mapping of M. In some embodiments, the M and M⁻¹ may be computed by the attribute indices encoder 612 as input to the attribute vectors encoder 616.

In some embodiments, an attribute traverse may use the following process to determine an encoding order for corner attributes, as well as prediction neighborhood information.

```
□ Initialize attributeStatus = {false, false, ... , false}
□ Initialize cornerStatus = {false, false, ... , false}
□ For i = 0 ...A − 1
  ∘ Let j = M⁻¹(i) (traverse attributes according to their decoding order
  ∘ Compute attribute prediction information for attribute vector aⱼ
  ∘ Encode attribute vector aⱼ
  ∘ Set attributeStatus[i] = true
  ∘ Insert index j in the priority queue Q
    □ Various priority criteria could be used to guide the traversal of the mesh,
    such as:
```

∘ Valence-based traversal (i.e., priority = the number of traversed
corner incident to a vector attribute),
∘ Geometry-based (i.e., priority = the sum of Dimond angles
associated with traversed corner incident to a vector attribute, cf. for
definition of diamond angles and the details of their computation
Generation)

```
∘ While Q is not empty
    □ Extract the highest priority element k of Q
    □ Use the corner table data structure to compute the set of corners ∇(k) =
    {c(0), c(1), ... , c(N − 1)} incidents to the attribute aₖ
    □ Initialize newAttributeIndices = { }
    □ For n = 0 ... N − 1
```

```
∘ If cornerStatus[c(k)] == true, then skip this corner
∘ Set c = c(k)
∘ Otherwise, find the left most unprocessed corner of c
  □ For h = 0 ... N
    □ lc = cornerTable.swingLeft(c)
    □ If lc >= 0 or cornerStatus[lc] == true, exit the
    loop
    □ Otherwise, c = lc
∘ Starting from corner c, traverse all corners on it is right.
  □ While c >= 0 and cornerStatus[c] == true
    □ nc = cornerTable.Next(c)
    □ pc = cornerTable.Next(p)
    □ If nc is not in newAttributeIndices, then insert nc
    in newAttributeIndices
    □ If np is not in newAttributeIndices, then insert np
    in newAttributeIndices
    □ Update priorities for attribute vectors associated with
    the two corners nc and pc
    □ Update c = cornerTable.swingRight(c)
∘ Encode the newly traversed attributes
  □ For aₕ in newAttributeIndices
    □ If attributeStatus[h] == true, then update the
      priority of attribute aₕ
    □ Otherwise,
      □ Compute attribute prediction information for
        attribute vector aₕ (See Section 2)
      □ Encode attribute vector aₕ
      □ Update the priority of attribute aₕ
      □ Set attributeStatus[h] = true
```

In some embodiments, the attribute prediction information for an attribute aₕ consists of zero, one, or two attribute predictors depending on the number of already encoded/decoded neighbors that could be leveraged for prediction. Each attribute predictor stores the following information:
Three attribute indices (α, β, γ),
Their corresponding vertex indices (A, B, Γ), and
The index Φ of a vertex associated attribute aₕ.

In some embodiments, the predictors are derived as follows:

```
□ Use the corner table data structure to compute the set of corners ∇(h) =
{c(0), c(1), ... , c(N − 1)} incidents to the attribute aₖ
□ For c in ∇(h)
  ∘ Let v be the vertex index associated with the next corner c(n)
  ∘ nc = cornerTable.Next(c)
  ∘ pc = cornerTable.Previous(c)
  ∘ Let na be the index attribute vector associated with the next corner nc
  ∘ Let pa be the index attribute vector associated with the previous corner pc
  ∘ Let nv be the vertex index associated with the next corner nc
  ∘ Let pv be the vertex index associated with the next corner pc
  ∘ If attributeStatus[na] == true and attributeStatus[pa] == true, then the
  two attributes na and pa are available for prediction
```

```
□ oc = cornerTable.Opposite(c)
□ Let oa be the index attribute vector associated with the opposite corner oc
□ If oc ≥ 0 and attributeStatus[oa] == true, then the attributes oa is
also available for prediction (3-neighbors predictor)
  ∘ Store the following predictor
    □ (α = na, β = pa, γ = oa)
    □ (A = nv, B = pv, Γ = ov),
    □ Φ = v
□ Otherwise, the attributes oa is not available for prediction
  ∘ Store the following predictor (2-neighbors predictor)
    □ (α = na, β = pa, γ = −1)
    □ (A = nv, B = pv, Γ = −1),
    □ Φ = v
```

```
  ∘ Otherwise, if attributeStatus[na] == true, then only the attributes na is
  available for prediction
```

```
□ Store the following predictor (1-neighbor predictor)
  ∘ (α = na, β = −1, γ = −1)
  ∘ (A = nv, B = −1, Γ = −1),
  ∘ Φ = v
```

```
  ∘ Otherwise, if attributeStatus[pa] == true, then only the attributes pa is
  available for prediction
```

```
□ Store the following predictor
  ∘ (α = pa, β = −1, γ = −1)
  ∘ (A= pv, B = −1, Γ = −1),
  ∘ Φ = v
```

In some embodiments, the generated predictors are stored in a local priority queue of size NQ=2. A predictor is inserted in the queue if and only if:
The queue is not full, or
The predictor leverages a higher number of neighboring attributes (i.e., 3-neighbor predictors have a higher priority than 2-neighbor predictors, which have a higher priority than 1-neighbor predictors).

### Attribute Vector Encoding

In some embodiments, an attribute vector encoder, such as attribute vector encoder 616, takes as inputs reordered position and geometry indices, such as produced by geometry encoder 610, as well as a determined encoding order (e.g., traversal order), prediction neighborhood information, and the attribute vectors themselves (that are to be encoded). Since the attribute vector encoding is downstream of the attributes indices encoder 612 and the attribute traverser 614, the attribute vector encoder 616 may treat vertex attributes and corner attributes in a similar manner. For example, for vertex attributes the attribute indices encoder and the attribute traverser blocks of the overall encoder are simply passthrough blocks since vertex attributes use the same connectivity and the same encoding order as the ones used for geometry encoding. Also, the corner attributes have already been handled by the attribute indices encoder 612 and the attribute traverser 616.

In some embodiments attribute vectors may be encoded using a two-step process in which the attribute vectors are first prediction (using a signaled prediction configuration) and prediction residuals are further entropy encoded.

As an initial prediction step, an attribute vector for a seed vertex of an interconnected component may be predicted, for example, using one or more previously processed seed vertices attribute vectors and a determined prediction configuration.

For example, let K be the number of connected components (CCs) in the mesh and (Sₖ)_{k={0, . . . , K-1}} the indices of the first vertex to be encoded in each CC (e.g., the seed for each CC).

A cache cache C of a predefined size (e.g., 4, 8, or 16) is maintained, which keeps track of the last N CC seeds. The cache is initially empty. Every time a CC seed is encoded, its index is added to C. If C is full the oldest seed is evicted from C. In some embodiments, other strategies for considering insertion and eviction of seed indices in C maybe considered, such as if a new seed is too close in terms of 3D position to existing seeds it may not be inserted in C or it may be removed from C.

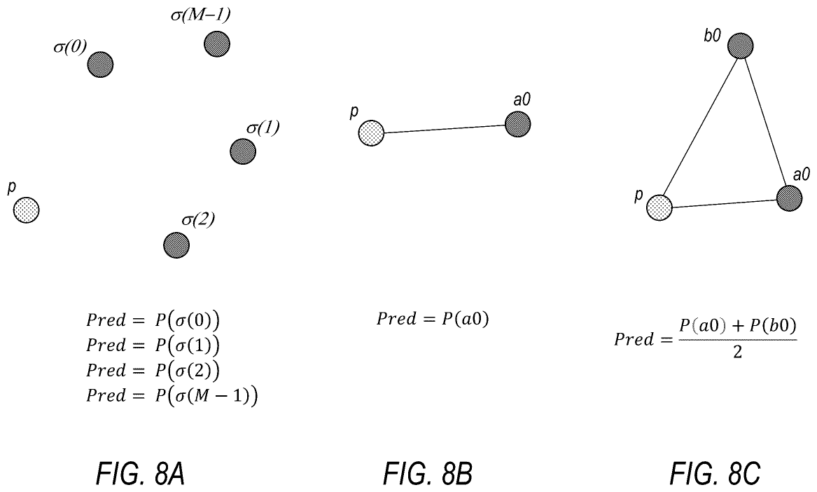

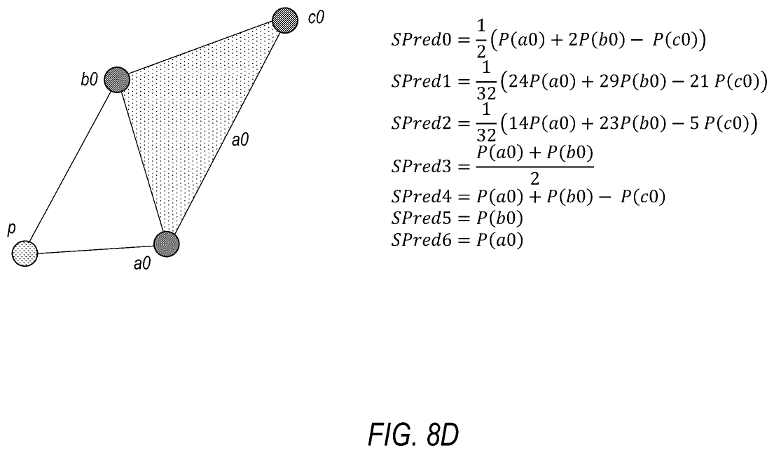

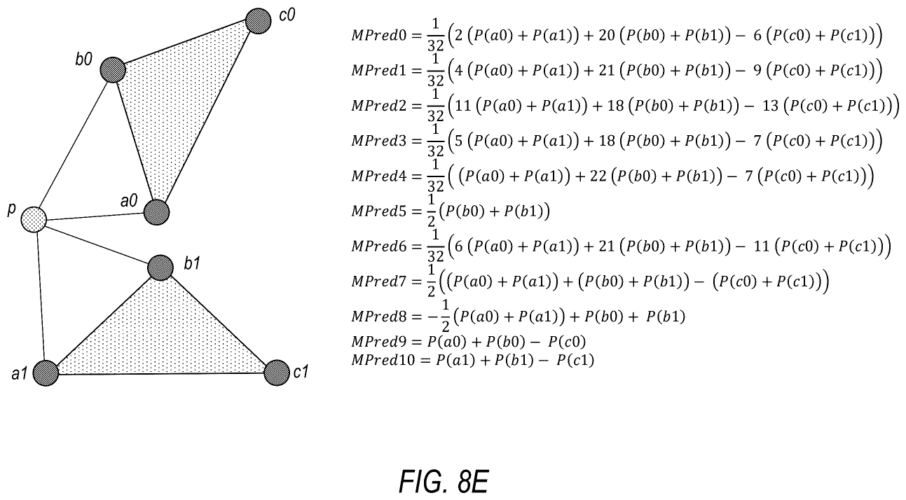

The predictors from the cache to be used in predicting a seed vertex according to a given one of the prediction configurations shown in FIGS. 8A-8E may be selected, e.g., a subset Σ of size M of the indices in C. The subs-et may be a fixed selection or may be adaptive selection that maximizes the 3D coverage of the selected seeds used to predict the next seed vertex.

In some embodiments, both the encoder determines the index k of the best predictor in Σ for example based on:
Minimizing the number of bits used to encode the prediction residual and the index k.
Rate-Distortion performance in case of lossy compression.
Minimizing other metrics used as proxy for the number of bits of the RD performance (e.g., L¹, L², L^{k}, and L^{∞} norms of the prediction residual)

The index k is signaled and indicates a given one of the prediction configurations shown in FIGS. 8A-8E that are to be used.

Also, in some embodiments, various prediction modes may be used for a selected prediction configuration. For example, single-way prediction may use one of the following modes:

```
□ Single-way prediction
  ∘ Mode0 = { SPred0, SPred4, SPred5, SPred6}
  ∘ Mode1 = { SPred1, SPred4, SPred5, SPred6}
  ∘ Mode2 = { SPred2, SPred4, SPred5, SPred6}
  ∘ Mode3 = { SPred3, SPred4, SPred5, SPred6}
```

Also, multi-way prediction may use one of the following modes:

```
□ Multi-way prediction
  ∘ Mode0 = { MPred0, SPred8, MPred9, MPred10}
  ∘ Mode1 = { MPred1, MPred8, MPred9, MPred10}
  ∘ Mode2 = { MPred2, MPred8, MPred9, MPred10}
  ∘ Mode3 = { MPred3, MPred8, MPred9, MPred10}
  ∘ Mode4 = { MPred4, MPred8, MPred9, MPred10}
  ∘ Mode5 = { MPred5, MPred8, MPred9, MPred10}
  ∘ Mode6 = { MPred6, MPred8, MPred9, MPred10}
  ∘ Mode7 = { MPred7, MPred8, MPred9, MPred10}
```

In some embodiments, the encoder may switch between prediction modes with a predefined update period. For example, the same single-way and multi-way modes may be used for V-consecutive predictions. Then, after V predictions, the prediction mode may be updated for example by:
explicitly writing in the bitstream the index of the new prediction mode; or
implicitly a deterministic update strategy may be used that considers the performance of the various modes observed over the last prediction period or over a subset of the already encoded vertices, or over all the encoded vertices so far.

For each vertex, the encoder:

```
□ determines the index k of the best predictor from the list of predictors of the current
prediction mode
  ∘ Minimize the number of bits used to encode the prediction residual and the index
  k.
  ∘ Rate-Distortion performance in case of lossy compression
  ∘ Minimize other metrics used as proxy for the number of bits of the RD performance
  (e.g., L¹, L², L^{k}, and L^{∞} norms of the prediction residual)
□ Encode the index k
  ∘ Arithmetic coding
  ∘ Entropy coding
  ∘ Universal codes
  ∘ ...
□ Encode the residuals
```

In some embodiments, binarization may be used to encode the prediction configuration and/or prediction mode to be used to predict the seed vertices and/or to encode the prediction residuals.

```
□ Encoding the prediction mode index
  ∘ encode the bits from the most significant bit to the least significant bit
  ∘ encode the most significant bit with the binary arithmetic context 0
  ∘ encode the k-th bit with the binary arithmetic context selected based on the values
  of the last (k-1) encoded bits
□ Encoding of the predictor index
  ∘ Encoding process
    □ Encode one bit to specify if the predictor index is 0
    □ if it is not 0, encode one bit to specify if the predictor index is 1
    □ if it is not 2, encode one bit to specify if 2 or 3
```

In some embodiments, an arithmetic context selection may be used for the binarization encoding. Different contexts are maintained for each of the prediction configurations. Also, different context may be used based on the shapes of the adjacent triangles.

### Efficient Coding of Corner and Vertex Attributes

As discussed at length above, mesh geometry information 100 (such as vertices, corners, faces, etc.) can be associated with attribute information 200 (such as texture coordinates, normal vectors, color information, etc.) by mapping their geometry indices 112 and attribute indices 212. As shown with vertex to attribute mapping 302 in FIG. 3, mappings can be defined by explicitly referencing geometry indices 112 and attribute indices 212. For example, mapping 302 explicitly specifies the indices “0/0” to indicate a corner is 1) associated with a vertex having index P0 at position vector (0 0 0) and 2) associated with attribute index UV0 with attribute vector (0.25, 0.25). This approach is supported by various geometry definition formats such as the OBJ format, developed by Wavefront Technologies. An advantage of this approach is that it provides precise control over the association between geometry and attributes, making it ideal for applications in which texture mapping or normal vector calculations require high accuracy. This more verbose approach, however, is less efficient from a storage and transmission standpoint as it generally uses more data to define relationships.

Geometry indices 112 and attribute indices 212 can alternatively be defined implicitly in which the relationship between geometric components and attributes is defined by the order of elements in a data structure. In the example below, positions of four vertices having indices 0-3 are defined and grouped into two polygons (specifically triangles) defined by the array [0, 1, 2, 2, 1, 3]. A six set of normals is also defined and associated with the six corners of the triangles.

```
def Mesh “Square”
{
  point3f[ ] points = [
      (0.0, 0.0, 0.0),
      (0.0, 0.0, 1.0),
      (0.0, 1.0, 0.0),
      (0.0, 1.0, 1.0)
      ]
  int[ ] faceVertexCounts = [3, 3]
  int[ ] faceVertexIndices = [0, 1, 2, 2, 1, 3]
  # normals specified as corner attribute with implicit indices
  normal3f[ ] normals = [
        (1.0, 0.0, 0.0),
        (−0.5, 0.5, 0.0),
        (0.4, −0.6, 0.0),
        (−0.3, 0.7, 0.0),
        (−1.0, 0.0, 0.0),
        (0.0, 1.0, 0.0),
      ] (
    interpolation = “faceVarying”
  }
....
```

Note, however, that the indices of these normals are implicitly defined based on the ordering of the normals in the array that defines the normal and the line “interpolation=‘faceVarying’” indicating the use of implicit attribute indices. In other words, the example program instructions do not explicitly refer to the normal indices (or corner indices) to associate the corners and normals. In contrast, the example program instructions included below define three positions of a texture that it associates with the four vertices defined above by explicitly referencing their associated attribute indices 0, 1, 2, and 2.

```
...
  # texture coordinates specified as vertex attribute with explicit indices
  float2[ ] primvars:st = [(0.0, 0.0), (0.0, 1.0), (1.0, 0.0)] (
    interpolation = “vertex”
  )
  int[ ] primvars:st:indices = [0, 1, 2, 2]
}
```

The ability to specify indices (e.g., corner attribute indices) implicitly is supported by various more advanced geometry definition formats such as the USD format noted above. This approach can be particularly beneficial when storing large three-dimensional models, as it allows for more efficient use of space. Accordingly, by not explicitly defining each corner attribute index, USD's implicit indexing scheme can reduce the overall size of the model data, making it suited for applications where storage or transmission constraints are a concern.

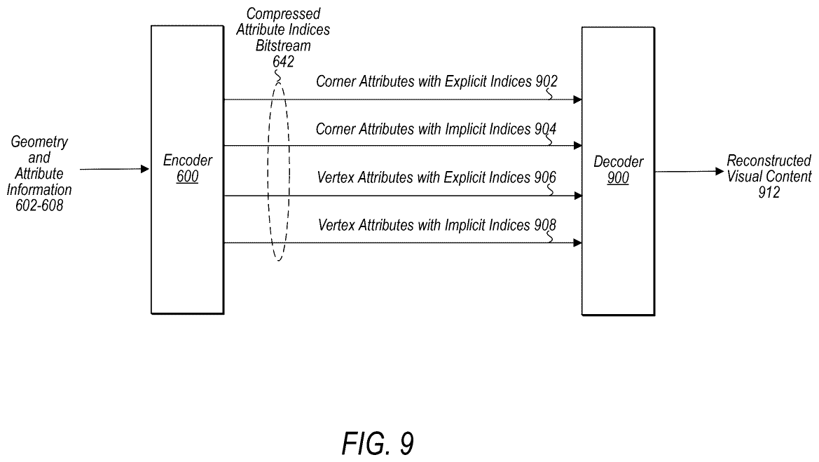

In order to support a variety of geometry definition file formats, the encoder and decoder described herein can efficiently encode and decode received attribute information that uses implicit or explicit indices to define relationships to vertices, corners, etc. An example of this is depicted in the illustrated embodiment of FIG. 9 in which encoder 600 is communicating, to decoder 900, an attribute indices bitstream 642 that can use one or more of the following: conner attributes with explicit indices 902, corner attributes with implicit indices 904, vertex attributes with explicit indices 906, and vertex attributes with implicit indices 908, such as indicated in the example table below:

| Condition | Scope | Indices |
|---|---|---|
| Attribute indices are different from | Corner | Explicit |
| [0, 1, 2, . . . , number of corners − 1] | | |
| Attribute indices are exactly | Corner | Implicit |
| [0, 1, 2, . . . , number of corners − 1] | | |
| Attribute indices are different from | Vertex | Explicit |
| geometry indices and each geometry | | |
| index has a unique attribute index | | |
| associated with it (e.g., texture | | |
| coordinates of M) | | |
| Attribute indices are the same as | Vertex | Implicit |
| geometry indices | | |

When attribute information 602-608 is initially received, encoder 600 may analyze the attribute information 602-608 to determine how indices are defined and then use one or more corresponding techniques to encode the information into a compressed attribute bitstream 642 that can be decoded by decoder 900 to reconstruct the corresponding volumetric visual content 912. As will be discussed, these techniques may include encoding information that preserves the implicit indices (such as shown with 904 or 908), which can be reconstructed explicitly on decoding by decoder 900. These techniques may alternatively include encoding information that explicitly specifies indices (such as shown with 902 or 906) but species indices for a deduplicated set of attribute vectors. Decoder 900 can then reconstruct the original set of attribute vectors on decoding based on the encoded information in the received bitstream 642.

In some embodiments, to compress corner attributes with implicit indices 904, encoder 600 implements one of two modes to encode attribute information: a skip mode or a deduplication mode. In the skip mode, the encoder preserves the implicitly defined attribute indices in the encoded information and includes, in the encoded information, metadata (e.g., an encoded Boolean flag/bit) indicating a presence of the implicitly defined attribute indices. When the decoder later receives encoded attribute bitstream that includes the encoded information, the decoder can determine, based on the included metadata, that the encoded attribute bitstream includes encoded information using implicitly defined attribute indices to map attribute vectors to corners of the polygons. The decoder can then generate the attribute indices for inclusion in the determined attribute information used to reconstruct the volumetric visual content. In some embodiments, the encoder and decoder implement the skip mode using the following process:
Skip coding the corner attribute indices and derive them on the decoder side as [0, 1, 2, . . . , number of corners].
The attributes values/vectors are encoded in a similar compressed manner as for corner attributes with explicit indices.

In the deduplication mode, encoder 600 analyzes the attribute vectors to detect unique ones of the attribute vectors and produces a deduplicated set of attribute vectors that includes only the unique attribute vectors. In other words, the encoder does not include redundant attribute vectors in order to reduce the amount of encoded bit stream data. Because the deduplicate set of attributes no longer has a one-to-one mapping with their corners, the encoder includes, in the encoded information, explicitly defined attribute indices of the deduplicated set of attribute vectors and includes, in the encoded information, metadata (e.g., an encoded Boolean flag/bit) indicating a presence of a deduplicated set of attribute vectors. When the decoder later receives encoded attribute bitstream that includes the encoded information, the decoder can determine, based on the metadata included in the encoded attribute bitstream, that the encoded attribute bitstream includes a deduplicated set of attribute vectors and explicitly defined attribute indices to associate the deduplicated set of attribute vectors to corners of the polygons. The decoder can expand the deduplicated set of attribute vectors by duplicating one or more of the deduplicated set of attribute vectors (to obtain the original set of attribute vectors before deduplication) and generating attribute indices for the expanded set of attribute vectors used to reconstruct the volumetric visual content. In some embodiments, the encoder and decoder implement the deduplication mode using the following process:
On the encoder side
   Detect unique attribute values/vectors.
   Convert the attribute to a corner attribute with explicit indices referencing the unique attribute values.
   Encode a flag in the slice header indicating that attribute values have been deduplicated.
   Encode the resulting corner attribute with explicit indices.
   Generate re-ordering information consistent with the attribute duplication process to be applied on the decoder side.
On the decoder
   Decode the unique attributes values and the associated indices.
   Duplicate the unique attribute values by using both the geometry and the attribute indices.

In various embodiments, encoder 600 determines whether to use the skip mode or the deduplication mode based on the amount of redundancy present in the attribute vectors. In some embodiments, the encoder determines the amount of redundancy present in the attribute vectors by performing an initial analysis of the attribute vectors before attempting to encode them. In other embodiments, the encoder determines the amount of redundancy present by attempting to encode the attribute information using both modes and selecting the mode that best compresses the resulting attribute bit stream.

In some embodiments, to compress vertex attributes with explicit indices 906, encoder 600 uses an encoding scheme in which an attribute index is encoded in its entity within a mapping data structure when a given attribute vector/index for an attribute is initially encountered when traversing the attribute vectors/indices being encoded. In response to encountering the given attribute vector/index again, the encoder, instead, encodes metadata (e.g., a delta index/offset) indicating where in the data structure the index was previously stored. Because this offset has a smaller size than the attribute index, this can result in the amount of encoded information in the encoded attribute bit stream being reduced. To implement this encoding scheme, the encoder may determine an initial map u indicating which vertex attribute indices are associated with which vertices. As discussed in sections above in some embodiments, however, the encoder may reorder the mesh geometry information (including reordering vertices) prior to encoding in order to better compress this information when encoding it to produce an encoded geometry bitstream. To account for this reordering, the encoder may generate a reorder map R that stores attribute indices for the reordered vertices—but only those indices with they are initially encountered during decoding.

To generate this map R, encoder 600 may initialize an attribute counter α to zero, initialize a predicted delta index Δ0 to zero, and initialize entries in the reordering map to a default value (e.g., −1). The encoder may then traverse vertices in their order of decoding (their reordered order). For each vertex v, the encoder uses map μ to determine an attribute index a (and thus corresponding the attribute vector) associated with that vertex v. If the attribute index a is new (i.e., the given attribute vector has not been encountered previously), the encoder stores the attribute index as α in the reordering map R at location a and encodes metadata (e.g., a bit encoded using Context Adaptive Arithmetic Encoder (CABAC)) indicating that the attribute index has not already been encoded. The encoder may then increment counter α. If the attribute index a is not new (i.e., the given attribute vector has been encountered previously), the encoder, instead, encodes metadata (e.g., another bit encoded using Context Adaptive Arithmetic Encoder (CABAC)) indicating that the attribute index has already been encoded. The encoder also encodes a delta value (Δ-Δ0) indicating an offset where the explicitly defined attribute index was stored in the reordering map data structure R. The encoder may determine Δ-Δ0 by determining Δ as R[a]−α−1. The encoder then sets Δ0 to Δ. In some embodiments, the encoder implements encoding vertex attributes with explicit indices using the following process:

```
• Build a map μ that describes for each vertex index v the attribute index a it corresponds
to.
• Encode μ as follows:
  ∘ Set the attribute counter α ← 0
  ∘ Set the predicted delta index Δ0 ← 0
  ∘ Initialize the reordering map R = [−1, −1, ... , −1]
  ∘ Traverse vertices in the decoding order.
  ∘ For each vertex v,
    □ Determine attribute index a associated with it
    □ Encode a bit, using Context Adaptive Arithmetic Encoder (CABAC),
    indicating whether the attribute index a is new (i.e. was not already
    encoded) or not.
    □ If a is new
      ∘ R[a] = α
      ∘ α ← α + 1
    □ Otherwise,
      ∘ Δ← R[a] − α − 1
      ∘ Encode (Δ − Δ0) by using a combination of cascaded binary
      arithmetic coding and Exponential Golomb codes.
      ∘ Update the predicted delta index Δ0 ← Δ
```

An example of program instructions executable to encode (Δ-Δ0) by using a combination of cascaded binary arithmetic coding and Exponential Golomb codes is depicted below:

```
auto symbol = Δ − Δ0;
if (symbol == 0) {
  enc.encode(1, ctx.isZeroCtx[k]);
  return;
}
enc.encode(0, ctx.isZeroCtx[k]);
// sign
if (symbol >= 0) {
  enc.encode(1, ctx.signCtx[k]);
} else {
  enc.encode(0, ctx.signCtx[k]);
  symbol = −symbol;
}
// is abs(Δ − Δ0) == 1
if (symbol == 1) {
  enc.encode(1, ctx.isAbsOneCtx[k]);
  return;
}
enc.encode(0, ctx.isAbsOneCtx[k]);
// abs(Δ − Δ0) >= 2
symbol −= 2;
const auto maxACValue = int32_t(ipower2minus1(maxSizeLog2));
auto* const acCtx = ctx.acCtx.data( ) + (k << maxSizeLog2);
if (symbol < maxACValue) {
  for (int32_t i = 0, j = maxSizeLog2 − 1; i < maxSizeLog2; ++i, −−j) {
    enc.encode(
      (symbol >> j) & 1, acCtx[ipower2minus1(i) + (symbol >> (j + 1))]);
  }
} else {
  for (int32_t i = 0; i < maxSizeLog2; ++i) {
    enc.encode(1, acCtx[ipower2minus1(i) << 1]);
  }
  auto& order = ctx.expGolombOrder[k];
  enc.encodeExpGolomb(symbol − maxACValue, order, ctx.expGolombCtx[k]);
  const auto p = symbol >> order;
  if (order && p == 0) {
    −−order;
  } else if (p > 1) {
    ++order;
  }
}
```

In some embodiments, when decoder 900 later receives encoded attribute bitstream, the decoder can decode the encoded attribute bitstream by determining, for a given vertex, whether an attribute index for the given vertex has been previously encoded in the attribute bitstream for another vertex. In response to determining that the associated attribute index has not been previously encoded (e.g., based on the encoded bit), the decoder can determine the attribute index by accessing the mapping data structure R at a location associated with the given vertex. In response to determine that the associated attribute index has been previously encoded, the decoder can determine the attribute index for the attribute vector by accessing the mapping data structure based on the encoded delta offset indicating a location associated with the other vertex.

In some embodiments, to compress vertex attributes with implicit indices 908, encoder 600 similarly implements a skip mode and a deduplication mode, which may be selected based on the redundancy of vertex attributes. In the skip mode, the encoder again preserves the implicitly defined attribute indices for the vertices in the encoded information and includes, in the encoded information, metadata (e.g., an encoded Boolean flag/bit) indicating a presence of the implicitly defined attribute indices. When decoder 900 later receives encoded attribute bitstream that includes the encoded information, the decoder can determine, based on the included metadata, that the encoded attribute bitstream includes encoded information using implicitly defined attribute indices to map attribute vectors to vertices. The decoder can then generate the attribute indices for inclusion in the determined attribute information used to reconstruct the volumetric visual content. In the deduplication mode, the encoder encodes analyzes the attribute vectors to detect unique ones of the attribute vectors and produces a deduplicated set of attribute vectors that includes only the unique attribute vectors. The encoder then includes, in the encoded information, explicitly defined attribute indices of the deduplicated set of attribute vectors. The decoder can then decode the encoded attribute bitstream by determining, based on the included metadata, that the encoded attribute bitstream includes a deduplicated set of attribute vectors and explicitly defined attribute indices and expanding the deduplicated set of attribute vectors by duplicating one or more of the deduplicated set of attribute vectors and generating attribute indices for the expanded set of attribute vectors. In some embodiments, the encoder and decoder implement the deduplication mode using the following process:
On the encoder side
   Detect unique attribute values.
   Convert the attribute to a vertex attribute with explicit indices referencing the unique attribute values.
   Encode a header a flag indicating that attribute values have been deduplicated.
   Encode the resulting vertex attribute with explicit.
   Generate re-ordering information consistent with the attribute duplication process to be applied on the decoder side.
On the decoder
   Decode the unique attributes values and the associated indices
   Duplicate the unique attribute values by using both the geometry and the attribute indices.
      The encoder can choose between the two modes and a flag is encoded in the slice header describing which mode was selected.

In some embodiments, these encoding and decoding techniques may be used for other types of geometry components (e.g., faces) and/or attribute types. These encoding and decoding techniques may also be combined with other techniques discussed above in other sections.

### Exemplary Computer System

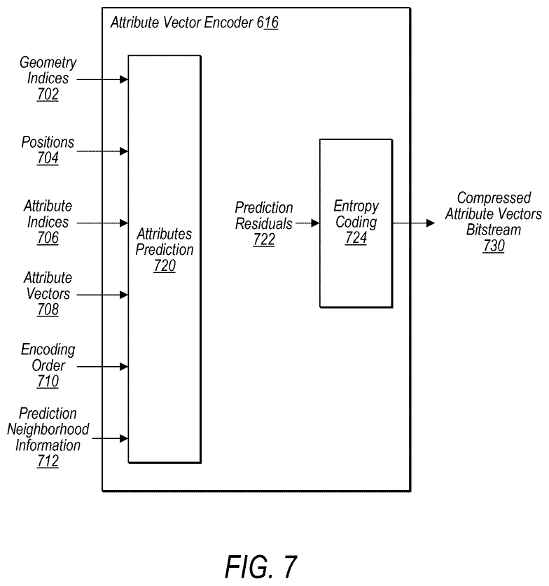

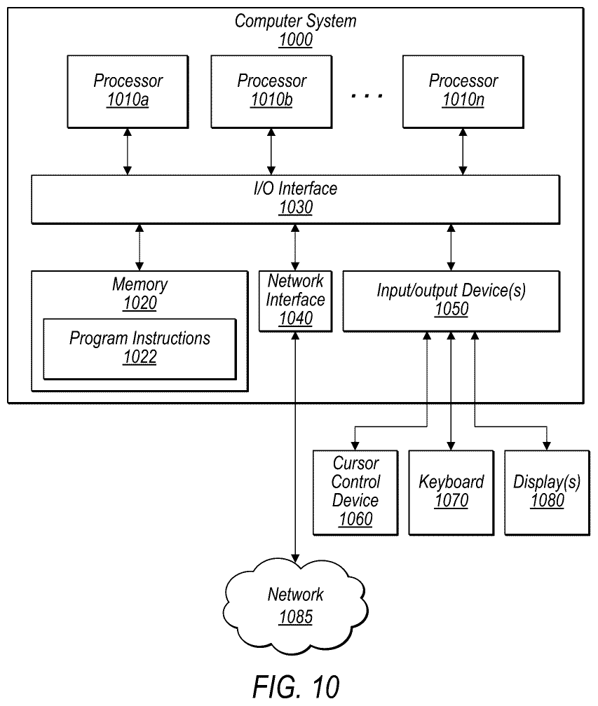

FIG. 10 illustrates exemplary computer system 1000 usable to implement an encoder or decoder as described above with reference to FIGS. 1-8). In different embodiments, computer system 1000 may be any of various types of devices, including, but not limited to, a personal computer system, desktop computer, laptop, notebook, tablet, slate, pad, or netbook computer, handheld computer, workstation, network computer, a camera, a set top box, a mobile device, a consumer device, video game console, handheld video game device, application server, storage device, a television, a video recording device, a peripheral device such as a switch, modem, router, or in general any type of computing or electronic device.

Various embodiments of an encoder or decoder, as described herein may be executed using one or more computer systems 1000, which may interact with various other devices. Note that any component, action, or functionality described above with respect to FIGS. 1-8 may be implemented using one or more computers such as computer system 1000 of FIG. 10, according to various embodiments. In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, computer system 1000 may be implemented as a system on a chip (SoC). For example, in some embodiments, processors 1010, memory 1020, I/O interface 1030 (e.g., a fabric), etc. may be implemented in a single SoC comprising multiple components integrated into a single chip. For example, an SoC may include multiple CPU cores, a multi-core GPU, a multi-core neural engine, cache, one or more memories, etc. integrated into a single chip. In some embodiments, an SoC embodiment may implement a reduced instruction set computing (RISC) architecture, or any other suitable architecture.

System memory 1020 may be configured to store compression or decompression program instructions 1022 and/or sensor data accessible by processor 1010. In various embodiments, system memory 1020 may be implemented using any suitable memory technology, such as static random-access memory (SRAM), synchronous dynamic RAM (SDRAM), nonvolatile/Flash-type memory, or any other type of memory. In the illustrated embodiment, program instructions 1022 may be configured to implement an encoder or decoder application incorporating any of the functionality described above. In some embodiments, program instructions and/or data may be received, sent or stored upon different types of computer-accessible media or on similar media separate from system memory 1020 or computer system 1000.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network 1085 (e.g., carrier or agent devices) or between nodes of computer system 1000. Network 1085 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or accessing data by one or more computer systems 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 10, memory 1020 may include program instructions 1022, which may be processor-executable to implement any element or action described above. In one embodiment, the program instructions may implement the methods described above. In other embodiments, different elements and data may be included.

Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.***

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A non-transitory computer readable medium having program instructions stored therein that are executable by a computing system to implement a decoder performing operations comprising:
receiving encoded volumetric visual content that includes an encoded geometry bitstream and an encoded attribute bitstream;
decoding the encoded geometry bitstream to determine mesh geometry information for volumetric visual content, wherein the mesh geometry information includes position information for a plurality of vertices and geometry connectivity information for forming polygons using the plurality of vertices;
decoding the encoded attribute bitstream to determine attribute information for the volumetric visual content, wherein the decoding includes:
determining that the encoded attribute bitstream includes encoded information using implicitly defined attribute indices to map attribute vectors to corners of the polygons; and
based on the determining, generating the attribute indices for inclusion in the determined attribute information; and
reconstructing the volumetric visual content using the mesh geometry information and the determined attribute information.

2. The computer readable medium of claim 1, wherein the operations further comprise:
receiving second encoded volumetric visual content that includes a second encoded geometry bitstream and a second encoded attribute bitstream;
decoding the second encoded geometry bitstream to determine second mesh geometry information for second volumetric visual content, wherein the second mesh geometry information includes second position information for a second plurality of vertices and second geometry connectivity information for forming second polygons using the second plurality of vertices;
decoding the second encoded attribute bitstream to determine second attribute information for the second volumetric visual content, wherein the decoding the second encoded attribute bitstream includes:
determining, based on metadata included in the second encoded attribute bitstream, that the second encoded attribute bitstream includes a deduplicated set of attribute vectors and explicitly defined attribute indices to associate the deduplicated set of attribute vectors to corners of the second polygons; and
expanding the deduplicated set of attribute vectors by duplicating one or more of the deduplicated set of attribute vectors and generating attribute indices for the expanded set of attribute vectors; and
reconstructing the second volumetric visual content using the second mesh geometry information and the decoded second attribute information.

3. The computer readable medium of claim 1, wherein the attribute information for the volumetric visual content includes a two-dimensional (2D) texture image; and
wherein the attribute vectors include coordinates of the 2D texture image.

4. The computer readable medium of claim 3, wherein the 2D texture image is an image of an unfolded three-dimensional (3D) mesh; and
wherein multiple ones of the coordinates of the 2D texture image are associated with a same geometry index of the plurality of vertices.

5. The computer readable medium of claim 1, wherein the attribute vectors include three-dimensional (3D) vectors representing one or more attributes of surfaces of the polygons formed using the plurality of vertices.

6. The computer readable medium of claim 5, wherein the one or more attributes of surfaces include one or more normals.

7. The computer readable medium of claim 1, further having program instructions stored therein that are executable by the computing system to implement an encoder perform encoding operations comprising:
receiving second mesh geometry information for second volumetric visual content, wherein the second mesh geometry information includes second position information for a second plurality of vertices and second geometry connectivity information for forming second polygons using the second plurality of vertices;
receiving second attribute information for the second volumetric visual content, wherein the second attribute information includes second attribute vectors for attributes associated with second corners of the second polygons;
determining that the second attribute information uses implicitly defined second attribute indices to map the second attribute vectors to the second corners based on an ordering of attribute vectors in the second attribute information;
based on the determining, encoding corresponding information indicating the mappings of the second attribute vectors to the second corners; and
sending a second encoded attribute bitstream decodable to reconstruct the second volumetric visual content, wherein the second encoded attribute bitstream includes encoded ones of the second attribute vectors and the encoded corresponding information indicating the mappings of the second attribute vectors to the second corners.

8. The computer readable medium of claim 7, wherein the encoding includes:
preserving, in the encoded corresponding information, the implicitly defined second attribute indices to map the second attribute vectors to the second corners; and
including, in the encoded corresponding information, metadata indicating a presence of the implicitly defined second attribute indices.

9. The computer readable medium of claim 7, wherein the encoding includes:
analyzing the second attribute vectors to detect unique ones of the second attribute vectors; and
based on the analyzing, producing a deduplicated set of attribute vectors that includes the unique attribute vectors;
including, in the encoded corresponding information, explicitly defined attribute indices of the deduplicated set of attribute vectors; and
including, in the encoded corresponding information, metadata indicating a presence of a deduplicated set of attribute vectors.

10. The computer readable medium of claim 9, wherein the encoding operations further comprise:
determining an amount of redundancy present in the second attribute vectors; and
based on the redundancy, determining whether to preserve the implicitly defined second attribute indices or to deduplicate the second attribute vectors.

11. A non-transitory computer readable medium having program instructions stored therein that are executable by a computing system to implement a decoder perform operations comprising:
receiving encoded volumetric visual content that includes an encoded geometry bitstream and an encoded attribute bitstream;
decoding the encoded geometry bitstream to determine mesh geometry information for volumetric visual content, wherein the mesh geometry information includes position information for a plurality of vertices and geometry connectivity information for forming polygons using the plurality of vertices;
decoding the encoded attribute bitstream to determine attribute information for the volumetric visual content, wherein the decoding includes:
determining, for a given vertex, whether an attribute index associated with the given vertex has been previously encoded in the attribute bitstream for another vertex; and
in response to determining that the associated attribute index has not been previously encoded, determining an explicitly defined attribute index for a attribute vector by accessing a mapping data structure at a location associated with the given vertex; and
in response to determine that the associated attribute index has been previously encoded, determining an explicitly defined attribute index for the attribute vector by accessing the mapping data structure based on delta offset indicating a location associated with the other vertex; and
reconstructing the volumetric visual content using the mesh geometry information and the determined attribute information.

12. The computer readable medium of claim 11, wherein the decoding includes decoding the delta offset using exponential Golomb codes.

13. The computer readable medium of claim 11, further having program instructions stored therein that are executable by the computing system to implement an encoder perform operations comprising:
receiving second geometry information for second volumetric visual content, wherein the second geometry information includes second position information for a second plurality of vertices and second geometry connectivity information for forming second polygons using the second plurality of vertices;
receiving second attribute information for the second volumetric visual content, wherein the second attribute information includes second attribute vectors for attributes associated with the second plurality of vertices;
determining that the second attribute information uses explicitly defined attribute indices to map the second attribute vectors to the second plurality of vertices; and
based on the determining, encoding corresponding information indicating the mappings of the second attribute vectors to the second plurality of vertices, wherein the encoding includes:
traversing the second attribute vectors to determine whether a given attribute vector has been encountered previously in the traversing;
in response to the given attribute vector not being encounter previously, encoding an explicitly defined attribute index to associate the attribute vector to one of the second plurality of vertices;
in response to the given attribute vector not being encounter previously, encoding metadata indicating that the explicitly defined attribute index for the attribute vector has already been encoded; and
sending a second encoded attribute bitstream decodable to reconstruct the second volumetric visual content, wherein the second encoded attribute bitstream includes encoded ones of the second attribute vectors and the encoded corresponding information indicating the mappings of the second attribute vectors to the second plurality of vertices.

14. The computer readable medium of claim 13, wherein the encoding includes:
initializing a mapping data structure indicating mappings of attribute indices of attribute vectors;
in response to the given attribute vector not being encounter previously, storing the explicitly defined attribute index of the given attribute vector in the mapping data structure for encoding; and
in response to the given attribute vector not being encounter previously, encoding a delta value indicating an offset where the explicitly defined attribute index of the given attribute vector was stored in the mapping data structure.

15. The computer readable medium of claim 13, wherein the encoding includes:
encoding information for the second geometry information, wherein the encoding includes reordering ones of the second plurality of vertices to improve a compression of the encoded information for the second geometry information; and
wherein the second attribute vectors are traversed based on the reordering of vertices.

16. A non-transitory computer readable medium having program instructions stored therein that are executable by a computing system to implement a decoder performing operations comprising:
receiving encoded volumetric visual content that includes an encoded geometry bitstream and an encoded attribute bitstream;
decoding the encoded geometry bitstream to determine mesh geometry information for volumetric visual content, wherein the mesh geometry information includes position information for a plurality of vertices and geometry connectivity information for forming polygons using the plurality of vertices;
decoding the encoded attribute bitstream to determine attribute information for the volumetric visual content, wherein the decoding includes:
determining, based on metadata included in the encoded attribute bitstream, that the encoded attribute bitstream includes a deduplicated set of attribute vectors and explicitly defined attribute indices to associate the deduplicated set of attribute vectors to the vertices; and
expanding the deduplicated set of attribute vectors by duplicating one or more of the deduplicated set of attribute vectors and generating attribute indices for the expanded set of attribute vectors; and
reconstructing the volumetric visual content using the mesh geometry information and the determined attribute information.

17. The computer readable medium of claim 16, wherein the operations further comprise:
receiving a second encoded attribute bitstream;
decoding the second encoded attribute bitstream to determine second attribute information for second volumetric visual content, wherein the decoding includes:
determining that the second encoded attribute bitstream includes encoded information using implicitly defined second attribute indices to map attribute vectors to vertices; and
generating the second attribute indices for inclusion in the determined second attribute information; and
reconstructing the volumetric visual content using the mesh geometry information and the determined second attribute information.

18. The computer readable medium of claim 16, having program instructions stored therein that are executable by a computing system to implement an encoder perform operations comprising:
receiving second mesh geometry information for second volumetric visual content, wherein the second mesh geometry information includes second position information for a second plurality of vertices and second geometry connectivity information for forming second polygons using the second plurality of vertices;
receiving second attribute information for the second volumetric visual content, wherein the second attribute information includes second attribute vectors for attributes associated with the second plurality of vertices;
determining that the second attribute information uses implicitly defined second attribute indices to map the second attribute vectors to the second plurality of vertices based on an ordering of attribute vectors in the second attribute information;
based on the determining, encoding corresponding information indicating the mappings of the second attribute vectors to the second plurality of vertices, wherein the encoding includes:
analyzing the attribute vectors to detect unique ones of the attribute vectors; and
based on the analyzing, producing a deduplicated set of attribute vectors that includes the unique attribute vectors;
including, in the encoded information, explicitly defined attribute indices of the deduplicated set of attribute vectors; and
sending a second encoded attribute bitstream decodable to reconstruct the second volumetric visual content, wherein the second encoded attribute bitstream includes encoded ones of the second attribute vectors and the encoded corresponding information indicating the mappings of the attribute vectors to the second plurality of vertices.

19. The computer readable medium of claim 18, wherein the operations further comprise:
determining that second attribute information uses implicitly defined attribute indices to map second attribute vectors to the second plurality of vertices;
encoding second corresponding information for the second attribute information, including:
preserving, in the second encoded information, implicitly defined attribute indices to map the second attribute vectors to the second plurality of vertices; and
including, in the second encoded information, metadata indicating the preserving.

20. The computer readable medium of claim 18, wherein the operations further comprise:
determining an amount of redundancy present in the attribute vectors; and
based on the redundancy, determining whether to preserve the implicitly defined second attribute indices or to deduplicate the second attribute vectors.
